(19) United States
(12) Patent Application Publication
(10) Pub. No.: US 2020/0300680 A1
(43) Pub. Date: Sep. 24, 2020

(54) WATER FLOW MONITORING DEVICE

(71) Applicants: Eli AMAR, Rechovot (IL); Mati SAMIMI GOLAN, Modieen Macabim Reute (IL)

(72) Inventors: Eli AMAR, Rechovot (IL); Mati SAMIMI GOLAN, Modieen Macabim Reute (IL)

(21) Appl. No.: 16/088,409

(22) PCT Filed: Mar. 24, 2017
(86) PCT No.: PCT/IL2017/050370

§ 371 Date: Sep. 25, 2018

(51) Int. Cl. G01F 15/00; G08B 13/06; H04Q 9/00; G01F 15/06; G01F 1/66; E03B 9/04

(52) U.S. Cl. CPC G01F 15/007; G08B 13/06; H04Q 9/00; G01F 15/063; H04Q 2209/60; G01F 15/006; E03B 9/04; H04Q 2209/40; G01F 1/662

(57) ABSTRACT

A fluid flow, particularly water, monitoring device that envelopes the body of a fluid conducting channel, where the inner volume of the device provides sufficient space for accommodating water flow sensors, controlling means on the sensors and wireless communication means for communicating the water flow data to a remote control center. The device comprises fluid flow sensors for external monitoring of water flow in a fluid conducting channel, where each flow sensor comprises controller for controlling and supervising operation of the flow sensor; communication module for wirelessly communicating the signals from the water flow sensors to a remote control unit; and housing for accommodating the water flow sensors and communication module and protectively enveloping them against tampering, vandalism and sabotaging.

### TECHNICAL FIELD

The present invention pertains to device for protection water theft and tampering. Particularly, the present invention pertains to a device for monitoring and measuring water flow in water conducting channels.

### BACKGROUND

Water theft and water tampering are two major hazards that require proper protection means for water reserves, ducts, channels and hydrants, especially when water supply for mass populations is concerned. Among these are fire hydrants, which are easily accessible on city streets for obvious reasons and, therefore, require improved protection and monitoring. Current solutions mainly concentrate on monitoring the faucet of the fire hydrant and alarming against any attempts to break or open it for illegal use.

Therefore, it is an object of the present invention to provide means for monitoring and measuring water flow and alarming against potential attempts of water theft and water tampering in water conducting channels, for example in fire hydrants.

It is yet another object of the present invention to provide a housing shielding envelope with certain geometry, with various alerting means in order to provide a protection from tampering, sabotaging and vandalism of the water monitoring apparatus.

It is still yet another object of the present invention to provide wireless communication within the inner space of the housing for communicating with various external control and database units through the housing envelope shield.

It is yet another object of the present invention to provide low cost water flow monitoring and alarming against water theft, tampering and sabotaging device that comprises high volume reproducible production capabilities with versatile geometrical shapes and sizes customized for different geometrical shapes, sizes and diameters of fire hydrants, water pipes, channels and ducts with a simple and reliable installation and assembly of its electronic and mechanical parts.

This and other objects and embodiments of the invention shall become apparent as the description proceeds.

### SUMMARY

In one aspect, the present invention provides a fluid flow monitoring device that envelopes the body of a water conducting channel, where the inner volume of the device provides sufficient space for accommodating water flow sensors, controlling means on the sensors and wireless communication means for communicating the water flow data to a remote control center.

Particularly, in one embodiment, the device of the present invention comprises:

water flow sensors for external monitoring of water flow in a water conducting channel, where each flow sensor comprises controller for controlling and supervising operation of the flow sensor;
communication module for wirelessly communicating the signals from the water flow sensors to a remote control unit; and
housing for accommodating the water flow sensors and communication module and protectively enveloping them against tampering, vandalism and sabotaging.

In one embodiment, the device comprises external controlling means for controlling operation of the flow sensors. For example, the device may further comprise controller for controlling and supervising the operation of the water flow sensors.

Still in another particular embodiment, the wireless communication module is operable in different wireless communication protocols, particularly GSM, CDMA, UMTS, CDMA2000, TD-SCDMA, GPRS, EDGE, Bluetooth, IEEE 802.11, IEEE 802.15.3, IEEE 802.15.4, IEEE 802.16, IEEE 802.20, IEEE 802.22, DECT, WDCT, UMA, HIPERLAN, BRAN and HIPERMAN.

In still another particular embodiment, the water flow sensors are non-invasive sensors. Particularly, the non-invasive sensors are ultrasonic sensors installed on the outer surface of the water conducting channel. The monitoring of the water flow comprises sending ultrasonic signals to the volume of the water conducting channel and receiving feedback signals according to the state of the flow inside.

In still another particular embodiment, the water flow sensors are invasive sensors. Particularly, visual or IR camera are introduced into the volume of the water conducting channel to monitor water flow.

In still another particular embodiment, the housing is hermetically sealed. Further, the housing is made of composite materials that provide sufficient volume for accommodating the components of the monitoring and alarming device and which are resistant to tampering, sabotaging and vandalism.

Still the composite materials that make the housing comprise fibers embedded in polymeric matrix. Particularly, the fibers may be selected from glass, carbon, aramid, basalt and wood fibers. The matrix may be selected from polyester PE (Polyethylene) and PP (Polypropylene), HDPE (High Density PE), MDPE (Medium-density polyethylene), LLDPE (Linear Low Density PE), and LDPE (Low Density PE), VLDPE (Very-low-density polyethylene), UHMWPE (Ultra-high-molecular-weight polyethylene), ULMWPE or PE-WAX (Ultra-low-molecular-weight polyethylene), HMWPE (High-molecular-weight polyethylene), HDXLPE, (High-density cross-linked polyethylene), PEX or XLPE (Cross-linked polyethylene), CPE (Chlorinated polyethylene), PVC (Poly Vinyl Chloride), m-LLDPE (Metallocene linear low density PE), PC (Polycarbonate), PVA (Polyvinylalcohol), EVA (Ethylene vinyl acetate) polymer, Polyester polymers (PSR), particularly PLA (Polylactic acid), PCL (Polycaprolactone), PEA (Polyethylene adipate), PBS (Polybutylene adipate), PET (Polyethyleneterphthalate), PBT (Polybutyleneterphthalate), PEN (Polyethylene naphtalane), Styrene polymers, particularly PS (Polystyrene), Styrene-Butadiene polymers, PUR (Polyurethane), foamed PUR, Fluorinated polymers, particularly Teflon, Nylon 6,6, and Nylon 6 and any combination thereof.

In still another particular embodiment, the polymer matrix comprises plasticizers, softeners, UV absorbers, static charge neutralizing fillers and flame retardants.

Still, in another particular embodiment the thickness of the housing wall is between 10 mm and 100 mm.

In one particular embodiment, the shape of the housing may be any shape that provides sufficient inner volume for accommodating the monitoring, controlling and communication components of the device. Particular shapes of the housing may be triangular or rectangular base pyramid, cubic or hexahedron. Preferably, the housing lacks any sharp edges or sides. Particularly, the shape of the housing may be spherical, bell-shaped or elliptical. Generally, the shape of the housing may be selected to blend with the shape of the water conducting channel or any water containing container. For example, bell-shape housing is better suitable for a fire hydrant from a visual perspective, blending better with the hydrant pipe and shape, and resistant to sabotaging, tampering and vandalism attacks.

In one particular example of the invention, the device of the present invention comprises:

ultrasonic sensors for external monitoring of water flow in a fire hydrant, where each sensor comprises controller for controlling and supervising operation of the flow sensor;
communication module for wirelessly communicating the signals from the ultrasonic sensors to a remote control unit; and
bell-shape housing for accommodating the ultrasonic sensors and communication module and protectively enveloping them against tampering, vandalism and sabotaging.

Still, the particular example detailed above, may further comprise controller for controlling and supervising the operation of the ultrasonic sensors.

In still another particular embodiment, the housing is made of composite material that comprises fiberglass and polyester.

Still in another particular embodiment, the device further comprises electromechanical switches attached to the housing and which are sensitive to any attempt to open, shake, move or tamper with the housing.

Further, the device may comprise RFID attached to the device that enables to continuously monitor its location.

Still in another particular embodiment, the housing that envelopes the body of a fluid conducting channel has inner volume with sufficient space for accommodating fluid flow sensors, controlling means on the sensors and wireless communication means for communicating the water flow data to a remote fluid flow monitoring device. Therefore, the device of the present invention comprises:
fluid flow sensors for external monitoring of fluid flow in the conducting channel, said fluid flow sensors comprising controllers for controlling and supervising operation of said fluid flow sensors;
communication module for wirelessly communicating signals from said fluid flow sensors to a remote control unit; and
housing for accommodating said fluid flow sensors and communication module and protectively enveloping them against tampering, vandalism and sabotaging.

In still another particular embodiment, the said flowing fluid inside the said conducting channel can be any type of natural, synthetic and or partially synthetic, fuel, drinking and cleaning liquids, liquid gas or gas phase, a mixture of gas and liquid, a mixture of several liquids all of which manufactured in industrial factories or used and/or consumed for public or private purposes.

The following describes particular non-limiting examples of the device of the present invention with reference to the drawings and without departing from the scope of the invention.

### BRIEF DESCRIPTION OF THE DRAWINGS

FIGS. 1A-C schematically illustrate fire hydrant monitored with a bell-shaped water flow monitoring device of the present invention shown in a top perspective (A), a sectional (B) and a bottom perspective (C) views.

FIG. 2 is a closer view of the bell-shape housing of the water flow monitoring device of the present invention.

FIGS. 3A-C show several cross-sections of the water flow monitoring device of the present invention.

FIGS. 4A-B show a zoom in perspective view of the ultrasonic detectors.

FIGS. 5A-C show cross sectional and perspective views of the of water flow monitoring device interior and exterior designs.

FIGS. 6A-C shows the water flow monitoring device electrical configuration located along its left top side in cross-sectional, perspective and in a zoom-in views.

FIG. 7 is a screenshot of the server screen with the different events recorded in a table.

### DETAILED DESCRIPTION OF THE DRAWINGS

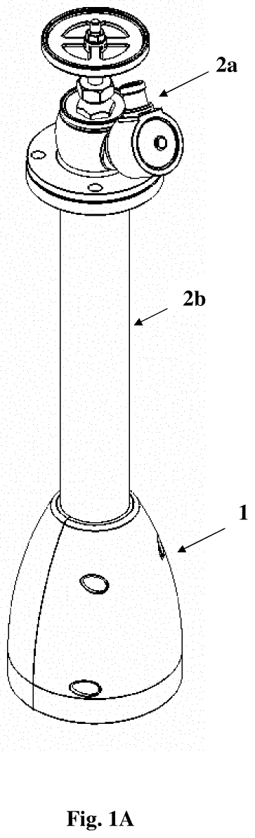

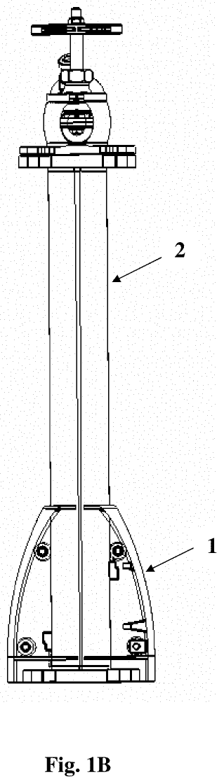

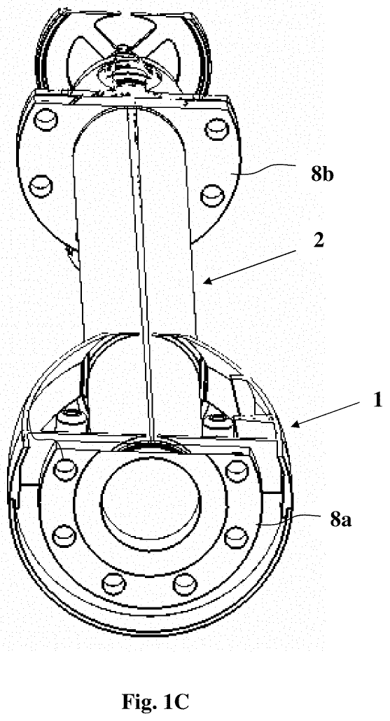

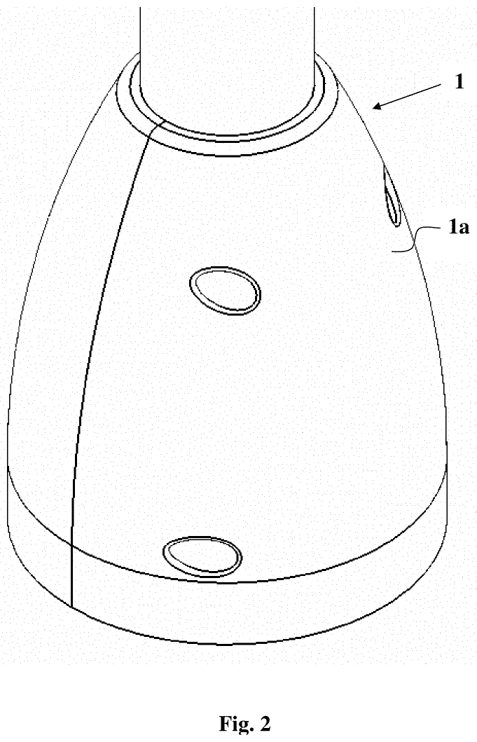

FIGS. 1A-C show bell-shape housing of the water flow monitoring device (1) enveloping a fire hydrant (2) shown in a top (A) and a bottom (C) perspective and a cross sectional (B) plane views (in one particular embodiment, the diameter of the pipe of the fire hydrant (2) may be 3-4 inches). As shown in FIGS. 1 B and C, the exterior housing part of the water flow monitoring device envelopes a certain segment of the fire hydrant pipe (2) along its sidewalls. The housing (1) has an open bottom end, encapsulating the lower flange (8b) of the fire hydrant pipe (1) and allowing it to be connected to the ground. A wireless communication from within the inner space of the device (1) through the housing shield (la) is enabled by fabricating the housing shield (la) from materials which are partially or fully transparent to the corresponding wireless communication wavelength ranges, however also exhibits mechanical properties which enable to mold them into strong physical shielding protection envelope in various designs and geometrical shapes. FIG. 2 shows a zoom-in view of the round, sharp edge and side free of the bell-shape housing shield (la) that imparts it additional protection against tampering or attempts to sabotage the housing and its interior components.

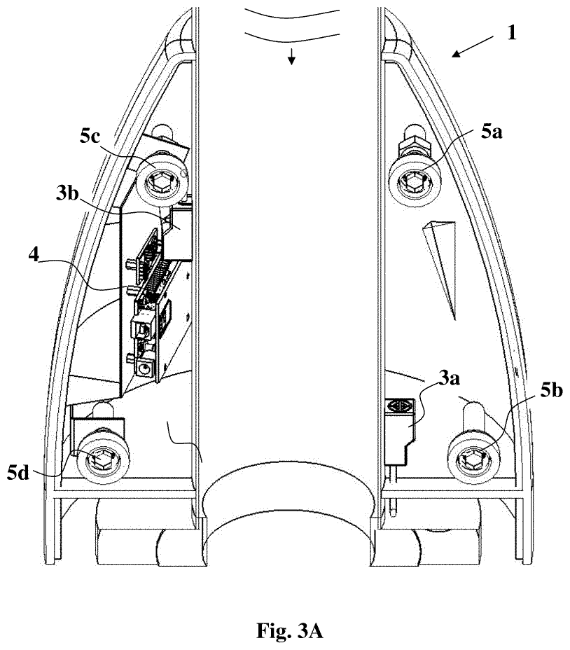

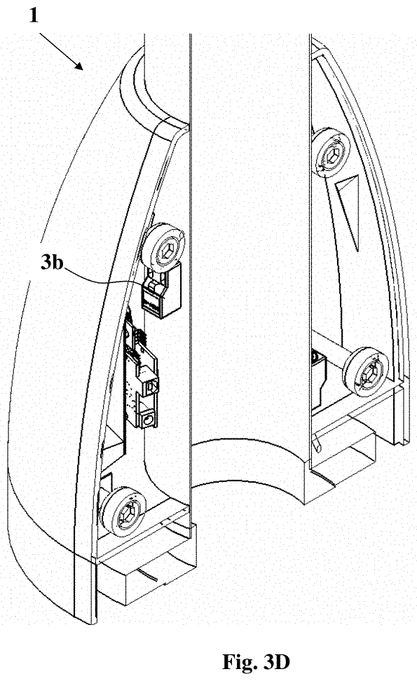

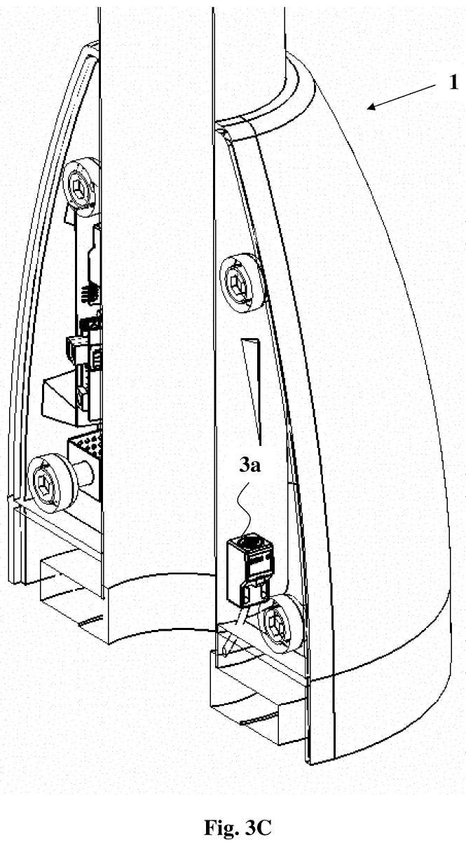

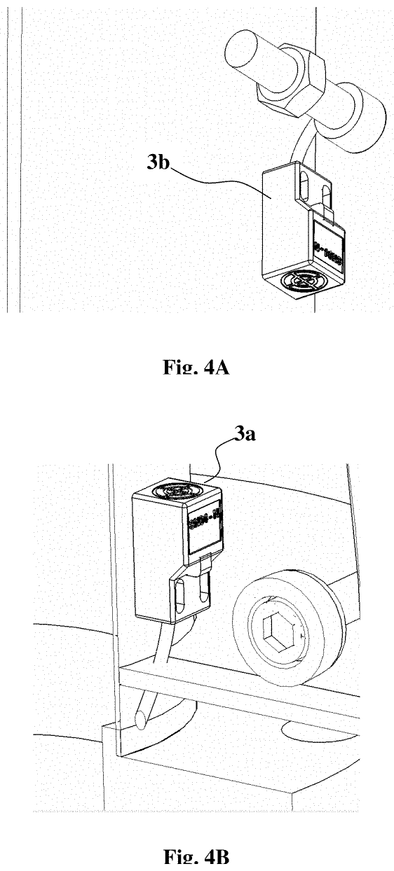

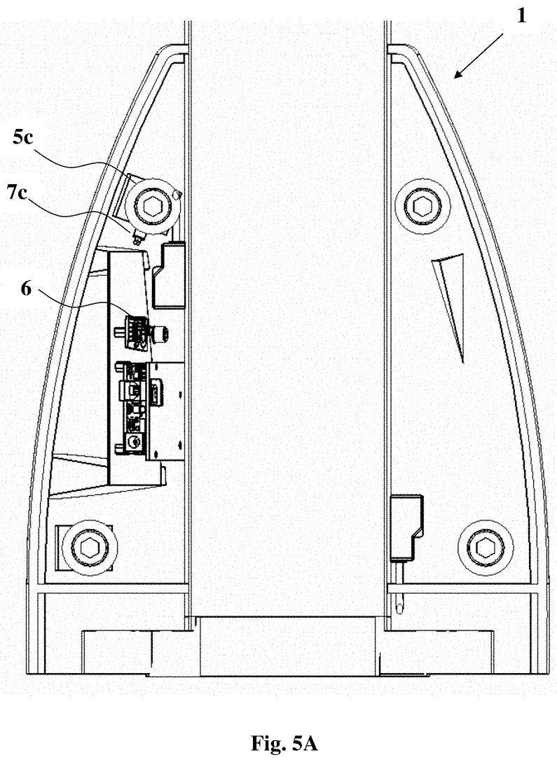

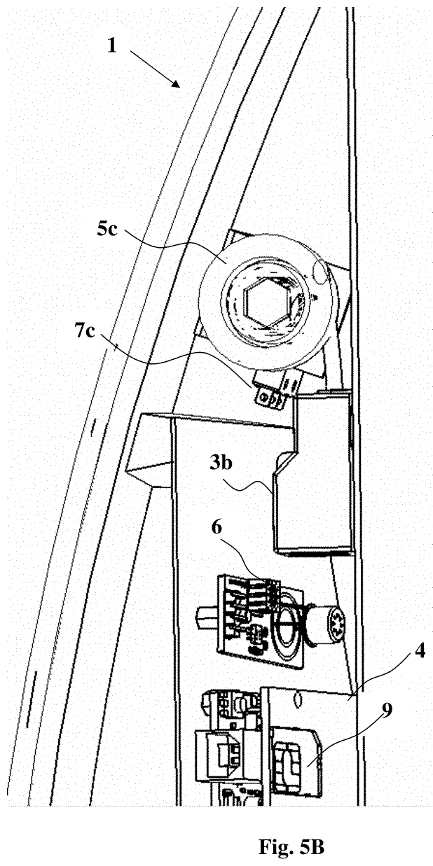

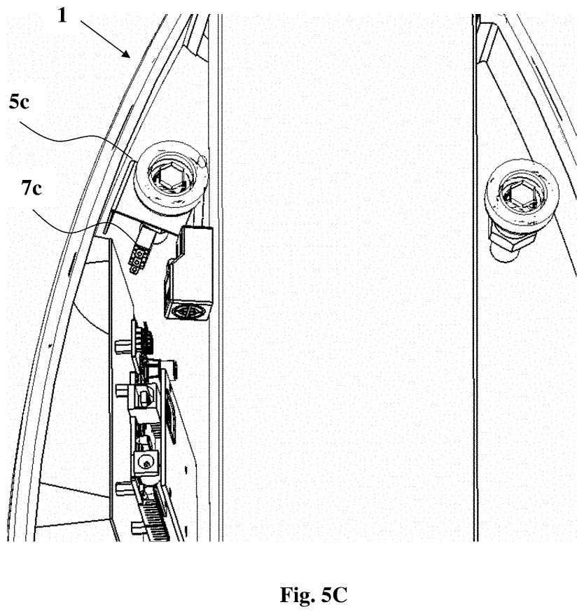

FIG. 3A is a cross section view showing the interior components of the device (1), where similar cross sections in a perspective view at different angles are shown in FIGS. 3B-C. Two ultrasonic sensors (3a), (3b), shown in a zoom-in view in FIG. 4 A-B, are located on opposite sides of the fire hydrant (2) at selected longitudinal distance between them and relative angles. The angles are measured relative to the transverse surface of the fire hydrant (2). The sensors (3a, 3b) are coordinated with each other for monitoring of the water flow, shown in the figure, in the fire hydrant (2), send a signal towards the fire hydrant (2) and receive feedback which they transmit to the wireless communication component located on board (4). The feedback received signals on the state of flow of the water inside the fire hydrant (2), so that continuous, periodic and frequent monitoring provides information on inconsistencies in water flow. As further shown in FIG. 3A-B, the housing envelope bell shape exterior part, i.e., housing shield (la) encapsulate the water monitor apparatus internal assembly that comprises mechanical and electrical components that surround a certain detected segment of the fire hydrant water pipe. The envelope housing part (la) is mechanically closed with several screws (5a-5d). Further, as shown in FIGS. 5A-C, several protection means were added to eliminate or minor the risk for intentional or unintentional attempts of tampering, sabotaging and vandalism of the water monitoring device. Such protection means comprise electromechanical micro-switches (for example, 7c in FIGS. 5A-C), which are attached to the screws (5a-5d) and alert on any attempts to remove its exterior envelope housing part (la), and a vibration sensor (6 in FIG. 5A) that alerts on any potential attempt to apply mechanical force or stress on the water monitor apparatus exterior enveloping housing part (la), in order to harm it and or malfunction some of its capabilities or functionalities. The board (4) further comprises SIM card (9 in FIG. 5B) for wireless communication with a wireless network for communicating data to an external control and monitoring unit.

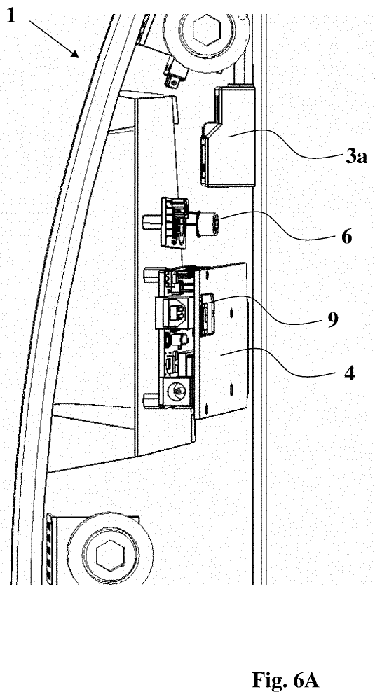

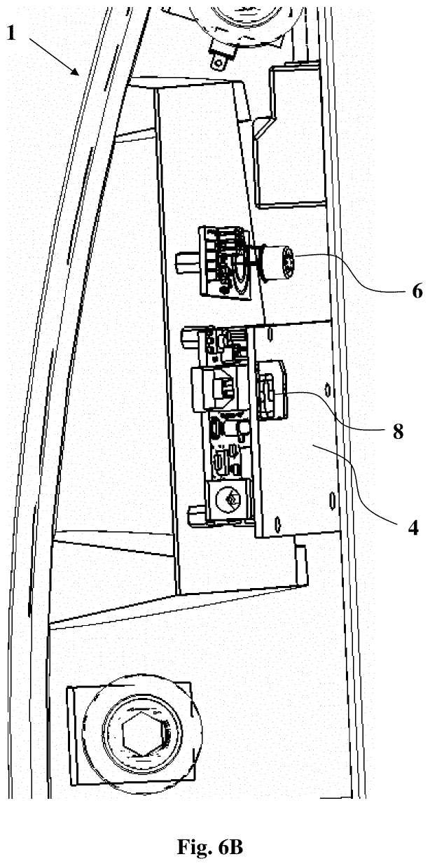

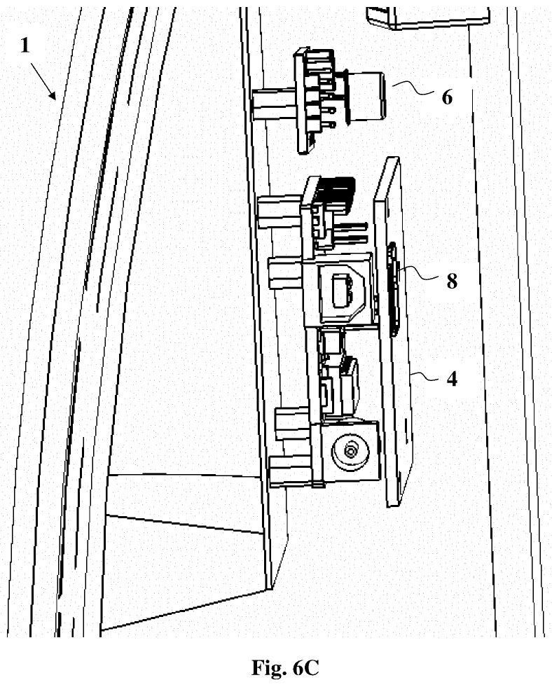

FIGS. 6 A-C show several cross-sections of the water monitoring apparatus exposing its electrical components including sensors and wireless communication components located on board (4). Beside the wireless communication components, the system is equipped with data processing capabilities and is able to analyze the data received from the ultrasonic sensors (3a, 3b), the electromechanical micro-switches (e.g., 7c) and vibration sensor (6). The system can trigger the wireless communication components to transmit relevant messages to user remote control units, such as cellphone or any kind of remote wireless receiver interface device, and update on the specific relevant data and or related problem, which interrupts the expected fire hydrant routine response. To this end, the system is equipped with a wireless transmitter connected to a SIM card (8), which is mounted in a specific location on the motherboard (4) inside a relevant input socket, and a dedicated cellular user ID. The system is thus capable of sending messages and or signal wirelessly, via cellular and or other short wavelength wireless means. In addition, the system is equipped with several batteries in order to enable its normal operation over long periods of time without any requirement for direct electrical wiring connection to electrical power source.

### System

Generally, the device communicates with a remote control unit in response to the following five triggers:

1) Water flowing out of the pipeline system—1.
2) Counter water flow into the pipeline system—2.
3) Opening of the housing of the device—3.
4) Shaking, moving or tampering with the housing (la) of the device (1)-4.
* For triggers (3)-(4), electromechanical micro-switches are attached to the screws (5a-5d) of the housing and alert on the opening of these screws.
5) Periodic communication check—5.
6) A supplemental trigger is identification of RFID for tracking the location of the device—6.

Completing data to the identification of each one of the triggers is provided as follows:

1) Flow counter (L/hour) in four digit code—XXXX.
2) Flow counter (L/hour) in four digit code—XXXX.
3) No completing data.
4) No completing data.
5) Battery state (Volts) in four digit code—XXXX.
6) RFID number (number) in four digit code—XXXX.

A hydrant log is used as the database that stores all transmissions from the device (1). The table generated also time tags every record with real-time tag.

Some examples of trigger identification are provided below:

1. The device (1) transmits on Feb. 9, 2016 at 21:23 identification of water flow of 2 cubic meter/hour and stamped this information with the following details: ID: 0547941025; Trigger: 1; Value: 2000. The line on the server of the remote monitoring center will show: 09-02-2016 21:23 0547941025 1 2000.
2. The device (1) transmits on Feb. 9, 2016 at 21:24 identification of opening of one of the screws of the housing (la) and stamped this information with the following details: ID: 0547941026; Trigger: 3; Value: 0000. The line on the server of the remote monitoring center will show: 09-02-2016 21:24 0547941026 3 0000.

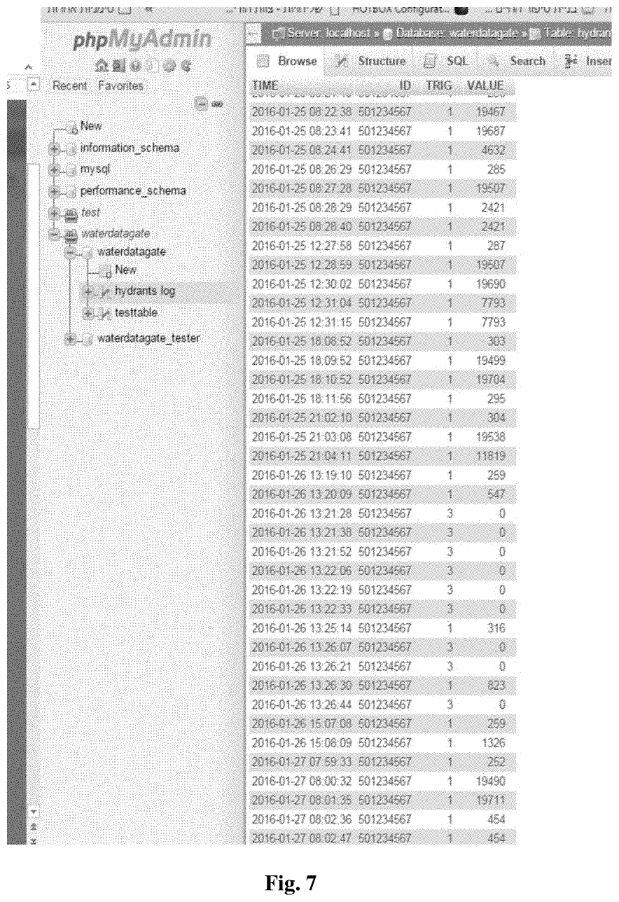

FIG. 7 is a screenshot of the server screen with the different events recorded on the table. When monitoring a plurality of fire hydrants, the distinction between them is their unique SIM number or other different marking means attached to each one of them (namely the ID attached to the water flow monitoring device (1)).

An ongoing event will be identified by repeating appearance of the device ID and trigger number. Analysis of the ongoing event related to water flow is the summation of flow rate value, assuming constant throughput in a selected period of time. For example, flow rate of 2 cubic meter/hour in three events, each event lasting 1 minute, will be calculated to be 100 litters=2000 litter/hour*6/3 minutes. The termination of an event may be determined after pause of the indication acknowledged for the event for a selected period of time, for example 2 minutes.

As detailed above, the housing shield (la) is made of a composite material, currently made of fiberglass and polyester, which imparts the water flow monitoring device (1) the following capabilities:

1) Wireless communication from within the inner space of the device (1) including data transmission through the housing shield (la).
2) Protection from tampering, sabotaging and vandalism.
3) Design that enables sufficient volume for sensitive components of the inner volume of the device (1).
4) Fast, low cost and reproducible production.
5) Ability to design the housing (la) in any geometry, particularly such that lacks sharp edges or sides, especially compared to metals that usually force boxes with sharp edges.
6) Easy electronic casing.

1. A water flow monitoring device for water conducting channel comprising:
water flow sensors for external monitoring of water flow in said water conducting channel, said water flow sensors comprising controllers for controlling and supervising operation of said water flow sensors;
communication module for wirelessly communicating signals from said water flow sensors to a remote control unit; and
housing for accommodating said water flow sensors and communication module and protectively enveloping them against tampering, vandalism and sabotaging.

2. The water flow monitoring device according to claim 1, further comprising controller for controlling and supervising operation of said water flow sensors.

3. A water flow monitoring device for water conducting channel comprising:
ultrasonic sensors for external monitoring of water flow in a fire hydrant, said ultrasonic sensors comprising controllers for controlling and supervising operation of said water flow sensors;
communication module for wirelessly communicating signals from said ultrasonic sensors to a remote control unit; and
bell-shape housing for accommodating said ultrasonic sensors and communication module and protectively enveloping them against tampering, vandalism and sabotaging.

4. The water flow monitoring device according to claim 3, further comprising controller for controlling and supervising operation of said ultrasonic sensors.

5. The water flow monitoring device according to claim 1, wherein said housing is made of composite material.

6. The water flow monitoring device according to claim 5, wherein said composite material comprises fiberglass and polyester.

7. The water flow monitoring device according to claim 5, wherein said composite material further comprises additives selected from plasticizers, softeners, UV absorbers, static charge neutralizing fillers and flame retardants.

8. The water flow monitoring device according to claim 1, wherein thickness of said housing is between 10 to 100 mm.

9. The water flow monitoring device according to claim 1, further comprising electro-mechanical switches attached to said screws of said housing.

10. The water flow monitoring device according to claim 1, wherein said wireless communication module is operable in different wireless communication protocols selected from GSM, CDMA, UMTS, CDMA2000, TD-SCDMA, GPRS, EDGE, Bluetooth, IEEE 802.11, IEEE 802.15.3, IEEE 802.15.4, IEEE 802.16, IEEE 802.20, IEEE 802.22, DECT, WDCT, UMA, HIPERLAN, BRAN and HIPERMAN.

11. The water flow monitoring device according to claim 1, wherein said housing is fabricated form martial which is partially or fully transparent to cellular and wireless short wavelength communication ranges.

12. The water flow monitoring device according to claim 1, wherein said water flow sensors are non-invasive sensors.

13. The water flow monitoring device according to claim 12, wherein said non-invasive sensors are ultrasonic sensors installed on outer surface of said water conducting channel.

14. The water flow monitoring device according to claim 1, wherein said water flow sensors are invasive sensors.

15. The water flow monitoring device according to claim 14, wherein said invasive sensors are selected from visual or IR camera, said camera is configured to be introduced into volume of said water conducting channel and monitor water flow.

16. The water flow monitoring device according to claim 1, wherein said housing is made of composite material that comprises fiberglass and polyester.

17. The water flow monitoring device according to claim 1, wherein said housing is configured to provide sufficient volume for accommodating components for monitoring and alarming.

18. The water flow monitoring device according to claim 19, wherein said housing is hermetically sealed.

19. The water flow monitoring device according to claim 1, wherein said housing is resistant to tampering, sabotaging and vandalism.

20. The water flow monitoring device according to claim 5, wherein said composite materials that make said housing comprise fibers embedded in polymeric matrix, wherein said fibers are selected from glass, carbon, aramid, basalt and wood fibers, wherein said polymeric matrix is selected from polyester PE (Polyethylene) and PP (Polypropylene), HDPE (High Density PE), MDPE (Medium-density polyethylene), LLDPE (Linear Low Density PE), and LDPE (Low Density PE), VLDPE (Very-low-density polyethylene), UHMWPE (Ultra-high-molecular-weight polyethylene), ULMWPE or PE-WAX (Ultra-low-molecular-weight polyethylene), HMWPE (High-molecular-weight polyethylene), HDXLPE, (High-density cross-linked polyethylene), PEX or XLPE (Cross-linked polyethylene), CPE (Chlorinated polyethylene), PVC (Poly Vinyl Chloride), m-LLDPE (Metallocene linear low density PE), PC (Polycarbonate), PVA (Polyvinylalcohol), EVA (Ethylene vinyl acetate) polymer, Polyester polymers (PSR), particularly PLA (Polylactic acid), PCL (Polycaprolactone), PEA (Polyethylene adipate), PBS (Polybutylene adipate), PET (Polyethyleneterphthalate), PBT (Polybutyleneterphthalate), PEN (Polyethylene naphtalane), Styrene polymers, particularly PS (Polystyrene), Styrene-Butadiene polymers, PUR (Polyurethane), foamed PUR, Fluorinated polymers, particularly Teflon, Nylon 6,6, and Nylon 6 and any combination thereof.

21. The water flow monitoring device according to claim 20, wherein said polymeric matrix further comprises additives selected from plasticizers, softeners, UV absorbers, static charge neutralizing fillers and flame retardants.

22. The water flow monitoring device according to claim 1, wherein shape of said housing is selected from triangular or rectangular base pyramid, cubic, hexahedron, spherical, bell-shaped and elliptical.

23. The water flow monitoring device according to claim 1, wherein said water monitoring device further comprises RFID attached to said device, said RFID is configured to continuously monitor location of said device.

24. The water flow monitoring device according to claim 1, wherein said water conducting channel is a fire hydrant.

25. A fluid flow monitoring device for fluid conducting channel comprising:
fluid flow sensors for external monitoring of fluid flow in the conducting channel, said fluid flow sensors comprising controllers for controlling and supervising operation of said fluid flow sensors;
communication module for wirelessly communicating signals from said fluid flow sensors to a remote control unit; and
housing for accommodating said fluid flow sensors and communication module and protectively enveloping them against tampering, vandalism and sabotaging.

26. The fluid flow monitoring device according to claim 25, wherein said fluid is selected from natural, synthetic or partially synthetic, fuel, drinking and cleaning liquids, liquid gas or gas phase and a mixture of gas and liquid, a mixture of several liquids.
